(19) United States
(12) Patent Application Publication
(10) Pub. No.: US 2005/0238292 A1
(43) Pub. Date: Oct. 27, 2005

(54) Field installable optical fiber connector having plastic splice holder and metal ferrule holder

(76) Inventors: Brandon A. Barnes, Ft. Worth, TX (US); Joshua D. Raker, Lewisville, TX (US)

Correspondence Address: CORNING CABLE SYSTEMS LLC, P O BOX 489, HICKORY, NC, 28603, US

(21) Appl. No.: 11/171,916

(22) Filed: Jun. 30, 2005

Related U.S. Application Data
(63) Continuation-in-part of application No. 10/985,541, filed on Nov. 10, 2004.
Application No. 10/985,541 is a continuation-in-part of application No. 10/808,057, filed on Mar. 24, 2004.

(51) Int. Cl. G02B 6/36

(52) U.S. Cl. 385/78

(57) ABSTRACT

A field installable optical fiber connector includes a connector housing, a ferrule, a ferrule holder, a splice holder, splice components and a cam member. The splice holder is disposed within the connector housing and defines a first cavity adjacent the forward end and a second cavity adjacent the rearward end. The ferrule holder is fixedly disposed within the first cavity and defines a recess adjacent the forward end. The ferrule is fixedly disposed within the recess and defines a longitudinal bore for receiving an optical fiber stub. The splice components are disposed within the second cavity and configured to receive and secure the optical fiber stub to a field fiber when the cam member disposed about the splice holder is actuated. The splice holder is made of a plastic material and the ferrule holder is made of a metal material to simultaneously satisfy cost, capacity, geometry, strength and machining requirements.

### CROSS REFERENCE To RELATED APPLICATIONS

This application is a continuation-in-part of U.S. patent application Ser. No. 10/985,541, filed on Nov. 11, 2004, which is a continuation-in-part of U.S. patent application Ser. No. 10/808,057, filed on Mar. 24, 2004.

### BACKGROUND OF THE INVENTION

1. Field of the Invention

The present invention relates generally to optical fiber connectors, and more particularly, to optical fiber connectors including a connector body made of a plastic material and a ferrule holder made of a metal material. In an exemplary embodiment, the invention is an optical fiber connector configured for performing a mechanical splice including a splice holder made of a plastic material and a ferrule holder made of a metal material.

2. Technical Background

Optical fiber connectors generally include a ferrule and a ferrule holder that retains the ferrule in a fixed position relative to the ferrule holder. The ferrule holder and the ferrule are typically biased (e.g., spring-loaded) relative to a connector housing to ensure physical contact between the end faces of the opposing ferrules when a pair of the connecters are mated together. In the case of an optical fiber connector configured for performing a mechanical splice, the ferrule holder also retains the splice components so that the splice location remains at a fixed distance from the rear of the ferrule. In particular, the ferrule holder secures both the ferrule and the splice components so that there is no relative movement between the mechanical splice and the ferrule that might damage the integrity of the optical fiber stub, or compromise the optical performance of the splice.

Both metal and plastic materials have been used to form the ferrule holder depending upon the primary design requirements for the connector. For example, a ferrule holder made of a metal material is substantially more robust and rigid than a ferrule holder made of a plastic material. Accordingly, a metal ferrule holder is typically used when the design of the connector includes a thin wall in the area of the ferrule that results in stress cracking due to stress concentrations when the connector is subjected to a side load. Furthermore, it is substantially easier to machine a metal ferrule holder, for example to provide threads on the exterior surface for engaging an internally threaded spring retainer. Alternatively, a ferrule holder made of a plastic material is typically used when the design of the optical fiber connector includes intricate geometry, for example a window, slot, taper, groove, reduced diameter or other feature in the area of the splice components. Furthermore, a ferrule holder made of a particular material is typically utilized when a manufacturer desires to optimize capacity (i.e., high volume production over short duration time cycles) and/or cost considerations.

Standard practice in the optical fiber connector industry is to use the same body to house both the ferrule and the splice components in a mechanical splice connector. Thus far, manufactures of optical fiber connectors have been able to optimize the design of connectors, and in particular mechanical splice connectors, by utilizing a metal ferrule holder when strength, rigidity and/or machining concerns are paramount and by utilizing a plastic ferrule holder when capacity, geometry and/or cost concerns are paramount. Recently, however, fiber optic networks have begun to require mechanical splice connectors of significantly smaller size, commonly referred to in the art as “small form factor” connectors. A small form factor connector includes an even thinner wall in the area of the ferrule, which requires precision machining and results in stress concentrations, while at the same time includes intricate geometry in the area of the splice components. Furthermore, the increasing use of small form factor mechanical splice connectors in new network designs is creating additional capacity and cost considerations. As such, manufacturers of mechanical splice connectors, and particularly small form factor connectors, must select either a metal ferrule holder that satisfies the strength and rigidity design considerations at the expense of intricate geometry, capacity and cost concerns, or select a plastic ferrule holder that satisfies the latter design considerations at the expense of the former concerns.

Thus, what is needed is a ferrule holder for a optical fiber connector, and in particular for a mechanical splice connector, that simultaneously provides the advantages of a plastic ferrule holder and the advantages of a metal ferrule holder. More particularly, what is needed is a ferrule holder that combines the cost, capacity and geometry advantages of a plastic ferrule holder with the strength, rigidity and machining advantages of a metal ferrule holder, thereby eliminating stress cracking in the thin-walled, threaded area adjacent the ferrule. Prior to the present invention, such a ferrule holder has not been available. The present invention provides an optical fiber connector including a connector body made of a plastic material and a ferrule holder made of a metal material fixedly disposed within the plastic connector body. In a particular embodiment, the connector body embodies a splice holder of a field installable mechanical splice connector. The plastic splice holder permits the intricate geometry in the area of the splice components to be cost effectively molded into the splice holder at a high volume rate. Simultaneously, the metal ferrule holder permits a thin wall to be precision machined with external threads for receiving a spring retainer element in the area of the ferrule and eliminates the potential for stress cracking.

Additional features and advantages of the invention will be set forth in the detailed description which follows, and in part will be readily apparent to those skilled in the art from that description or recognized by practicing the invention as described herein, including the following detailed description and claims, as well as the accompanying drawings. It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

FIG. 1 is an exploded perspective view of a optical fiber connector configured for performing a mechanical splice including a splice holder made of a plastic material and a ferrule holder made of a metal material.

FIG. 2 is an enlarged perspective view of the plastic splice holder and the metal ferrule holder of FIG. 1 shown in the disassembled configuration.

FIG. 3 is a longitudinal sectional view of the plastic splice holder and the metal ferrule holder of FIG. 1 shown in the assembled configuration.

### DETAILED DESCRIPTION OF THE EMBODIMENTS

Reference will now be made to the drawings in which exemplary embodiments of the invention are shown. The drawings together with the following detailed description provide a full and detailed written description of the invention, along with the manner and the process of making and using it, so as to enable one skilled in the pertinent art to make and use it without undue experimentation. The drawings and description also disclose the best mode of carrying out and practicing the invention presently known to the inventors. However, the examples set forth in the drawings and detailed description are provided by way of explanation of the invention and are not intended to limit the scope of the invention in any manner. Thus, this invention is intended to include any modifications and variations of the exemplary embodiments that come within the scope of the appended claims and their equivalents. The detailed description uses numerical and letter designations to refer to features shown in the drawings. Whenever possible, the same reference numerals and letters are used throughout the drawings to refer to the same or similar parts.

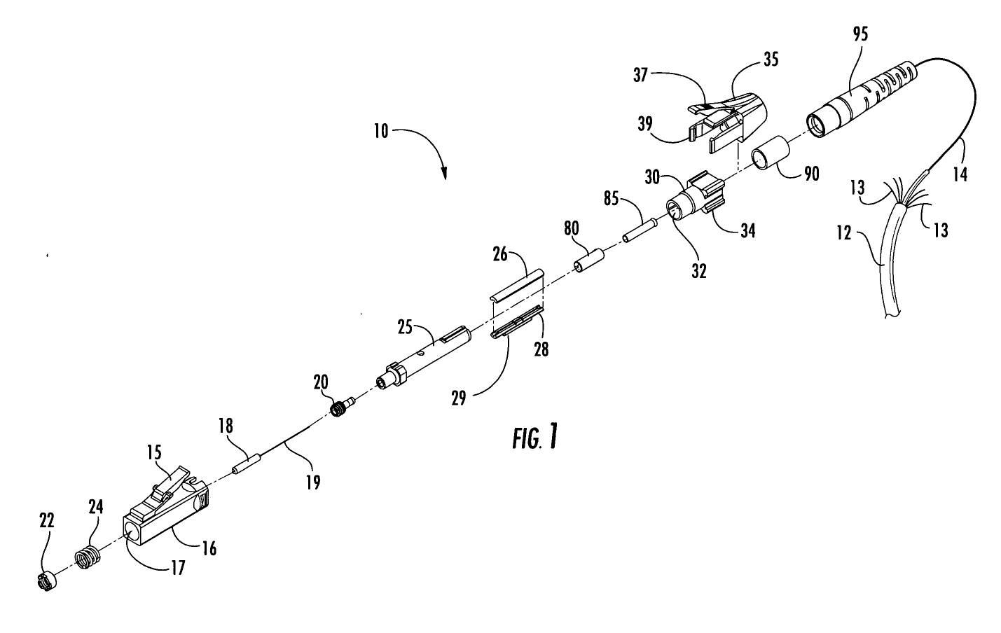

An optical fiber connector configured for performing a mechanical splice according to the invention is shown in FIG. 1, and is indicated generally herein at reference numeral 10. In particular, an LC style UniCam® field installable optical fiber connector available from Corning Cable Systems of Hickory, N.C. is shown and described. However, the invention is not intended to be limited to any particular style connector, to field installable connectors, or even to mechanical splice connectors in general. Instead, the invention is applicable to any style single-fiber or multi-fiber connector, including but not limited to SC, ST, FC, SC/DC, MT, MU and MTP, configured for being fusion spliced, mechanical spliced or direct connectorized to an optical fiber in the factory of the field as long as the connector comprises a connector body and a ferrule holder fixedly secured to the connector body. In the exemplary embodiments of the invention shown and described herein, the connector body embodies the splice holder portion of a conventional mechanical splice connector, and in particular, the splice holder portion of a fiber optic small form factor LC UniCam® field installable mechanical splice connector. The invention, however, is equally applicable to other types of optical fiber connectors comprising a connector body and a ferrule holder fixedly secured to the connector body wherein the connector body and the ferrule holder have different design requirements. Furthermore, the connector body may be made of any material that is different than the material of the ferrule holder. Although as described herein the connector body is made of a plastic material and the ferrule holder is made of a metal material, the connector body may likewise be made of a suitable metal material and the ferrule holder made of a suitable plastic material.

With particular reference to FIG. 1, optical fiber connector 10 is configured for being mechanically spliced to field fiber 14 of optical fiber cable 12. Field fiber 14 typically has a glass diameter of about 125 microns. Typically, field fiber 14 also comprises one or more coatings disposed about the optical fiber. The one or more coatings may have various diameters, including diameters ranging from about 245 microns to about 900 microns for a buffered optical fiber, without departing from the scope of the present invention. Mechanical splice connector 10 includes connector housing 16, ferrule 18, ferrule holder 20, spring element retainer 22, spring element 24, connector body 25, splice components 26, 28, and cam member 30. As will be described in greater detail below, connector body 25 embodies the splice holder portion of the mechanical splice connector 10 shown and described in the exemplary embodiment of the invention provided herein. In other embodiments (e.g., optical fiber connectors configured for performing a fusion splice or direct connectorization), the connector body 25 may embody the main connector housing, the ferrule holder housing or the inner housing as dictated by the particular design of the connector.

As shown, connector housing 16 defines an open interior 17 which extends longitudinally through the housing 16. Interior 17 is configured to receive spring element 24 and spring element retainer 22 inserted from the forward end of the connector housing 16 such that the spring element 24 is seated against a spring seat provided within interior 17. The rearward face of the spring element seat further serves as a positive stop to limit the forward movement of the connector body 25 (as will be described) into the interior 17 of the connector housing 16. Connector housing 16 also includes latching arm 15 extending outwardly from the connector housing 16 for securing the connector 10 in a conventional manner, for example to an adapter configured to receive opposing connectors 10 through a patch panel on a fiber optic distribution frame. Preferably, latching arm 15 is of a sufficient resiliency to permit the latching arm 15 to be depressed and then returned to a relaxed position once released. Preferably, connector housing 16 and latching arm 15 are formed of a suitable plastic material and are molded together in a unitary construction.

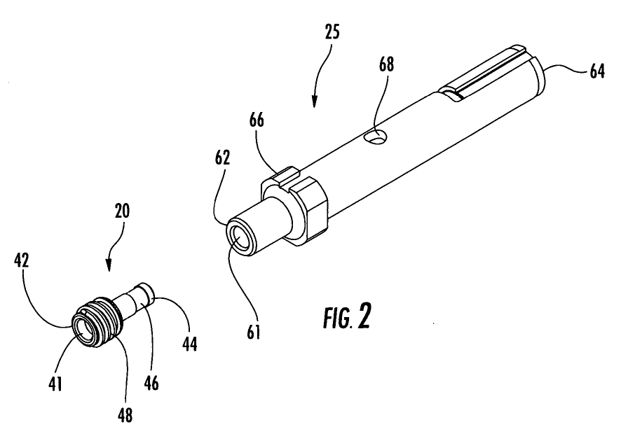

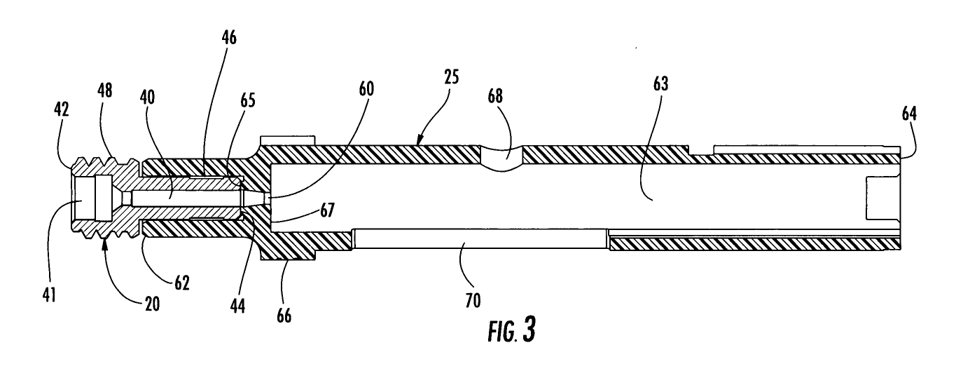

As shown in FIGS. 2 and 3, ferrule holder 20 extends longitudinally between a first (forward) end 42 and a second (rearward) end 44, and defines a longitudinally extending interior passageway 40. Passageway 40 further defines a recess 41 extending inwardly from the first end 42 of ferrule holder 20 that is sized to receive ferrule 18. Ferrule 18 is fixedly disposed within the recess 41 of the ferrule holder 20, for example by an interference or press fit, for a purpose to be described. Ferrule 18 is formed of any suitable, wear-resistant material such as ceramic, glass, metal, glass-reinforced epoxy or a polymer plastic. Because the ferrule holder 20 as described herein is made of metal, the ferrule 18 is sufficiently retained within the recess 41 of ferrule holder 20 by the interference fit and need not necessarily be further secured therein via an adhesive, such as epoxy. As is well known and will not be described further herein, ferrule 18 likewise comprises a first (forward) end and a second (rearward) end and defines a longitudinally extending bore for receiving at least one optical fiber. As shown in FIG. 1, optical fiber stub 19 is disposed within the bore of the ferrule 18 and extends rearwardly beyond the second (rearward) end of the ferrule 18. Preferably, optical fiber stub 19 extends at least about 5 mm beyond the second end of the ferrule 18, and more preferably, at least about 10 mm. Optical fiber stub 19 is preferably secured within the bore of the ferrule 18 with an adhesive, such as an epoxy. The free end of the optical fiber stub 19 is preferably cleaved with a good finish, the cleave angle typically being less than about one degree. The opposite (forward) end of the optical fiber stub 19 is typically polished flush with the end face of the ferrule 18 to facilitate optical transmission therethrough. However, as is known in the art, the optical fiber stub 19 may protrude forward from the end face of the ferrule 18 to ensure adequate physical contact between the optical fibers of opposing optical fiber connectors, especially when the optical fiber connectors comprise multi-fiber ferrules.

In prior field installable optical fiber connectors, such as those disclosed in related and co-pending U.S. patent application Ser. Nos. 10/985,541 and 10/808,057, assigned to the assignee of the present invention, the connector body 25 and the ferrule holder 20 comprise a unitary part formed of a single material. For example, the prior connector body/ferrule holder (referenced in the aforementioned patent applications as the ferrule holder) may be made entirely of plastic if the primary design considerations are cost, capacity and intricate geometry in the area of the splice components 26, 28. However, a ferrule holder made entirely of a plastic material is subject to stress cracking in the area of the ferrule where the wall thickness of the ferrule holder is reduced to receive the second (rearward) end of the ferrule and the exterior surface of the ferrule holder is threaded to receive the internally threaded spring element retainer 22. If the primary design considerations are strength, durability and machining, the ferrule holder may be made entirely of a stronger, more robust material, such as metal. However, the metal ferrule holder sacrifices the design considerations of cost, capacity and geometry in favor of reduced stress cracking, longevity and the ease of forming a threaded exterior surface. While it is possible to form a unitary ferrule holder from a molded hybrid of plastic and metal material, or from a composite material having material properties that satisfy all design considerations, any such process or material would necessarily add significantly to the cost of the ferrule holder and would only satisfy each of the primary design considerations to a lesser extent.

Instead, optical fiber connectors according to the present invention further comprise a connector body 25 in addition to the ferrule holder 20. In the exemplary embodiments of the field installable optical fiber connector 10 shown and described herein, the ferrule holder 20 is made of a suitable metal material having sufficient strength and rigidity to prevent stress cracking in the area of the ferrule 18. The material of the ferrule holder 20 is also capable of being readily machined to provide a threaded exterior surface for receiving the spring element retainer 22. The connector body 25 is made of a suitable plastic material that is capable of being molded cost effectively with intricate geometry features (e.g., window, slot, taper, groove, reduced diameter, etc.) in the area of the splice components 26, 28. By replacing the prior unitary ferrule holder with a ferrule holder 20 made of a metal material and a separate connector body 25 made of a plastic material, all of the primary design considerations are satisfied simultaneously. In the field installable optical fiber connector 10 disclosed herein, the connector body 25 functions as the splice holder in addition to securing the ferrule holder 20 (and hence the ferrule 18) at a fixed distance from the location of the splice components. Accordingly, in this detailed description of the optical fiber connector 10 shown in the accompanying drawing figures, the connector body 25 is also referred to as the splice holder 25.

As best shown in FIG. 3, the splice holder 25 comprises a first (forward) end 62 and a second (rearward) end 64 and defines a longitudinally extending interior passageway 60 in communication with passageway 40 of ferrule holder 20. Passageway 60 further defines a first cavity 61 (FIG. 2) extending inwardly from the first end 62 of the splice holder 25 and a second cavity 63 (FIG. 3) extending inwardly from the second end 64 of the splice holder 25. The first cavity 61 is sized and shaped (e.g., cylindrical) to receive the second end 44 of the ferrule holder 20 therein. In particular, first cavity 61 forms a mechanical stop feature 65 at its rearward end along the plane of intersection with passageway 60 such that the ferrule holder 20 is in a predetermined position when the second end 44 of the ferrule holder abuts against the mechanical stop feature 65. Alternatively, the rear shoulder defined by the threaded portion of the ferrule holder 20 could be mechanically stopped against the first end 62 of the splice holder 25. The ferrule holder 20 is fixedly disposed within the first cavity 61 of the splice holder 25 so that the ferrule 18 that is likewise fixedly disposed within the recess 41 of the ferrule holder 20 is maintained at a fixed distance from the splice components 26, 28, and more particularly, at a fixed distance from the location of the mechanical splice. The ferrule holder 20 may be fixed within the first cavity 61 of the splice holder 25 in any suitable manner, for example by a slight interference or press fit subsequently secured by ultrasonic welding or epoxy. As shown, a relief cut 46 is machined into the exterior surface of the metal ferrule holder 20 adjacent the second end 44 to facilitate the application of epoxy or to allow plastic from the splice holder 25 to flow in the event that ultrasonic welding is utilized to fixedly secure the ferrule holder 20 to the splice holder 25. Alternatively, the ferrule holder 20 could be insert-molded within the splice holder 25 in a conventional manner with the same or better control over the tolerance of the longitudinal position of the ferrule holder relative to the splice holder.

The splice holder 25 includes a shoulder 66 on the exterior surface adjacent the first end 62 of the splice holder 20 and proximate the intersection of the passageway 60 with the second cavity 63. The shoulder 65 is configured to be received within the interior 17 of connector housing 16 through the rearward opening. As is well known, the exterior of the splice holder 25 and the interior 17 of the connector housing 16 may comprise complimentary keying features (e.g., groove and pin; slot and protrusion) to ensure the correct orientation of the splice holder 25 relative to the connector housing 16. The orientation of the splice holder 25 (and thus the ferrule holder 20 and ferrule 18) relative to the connector housing 16 is particularly important when the ferrule 18 is a single-fiber angled physical contact (APC) ferrule, or a multi-fiber ferrule. Although not shown, the orientation of the ferrule holder 20 relative to the splice holder 25, and the orientation of the ferrule 18 relative to the ferrule holder 20 may be keyed in a similar manner to ensure that the ferrules 18 of opposing connectors 10 are properly oriented when the connectors are mated together. Preferably, splice holder 25 also defines a view port 68 extending through the exterior surface into second cavity 63 proximate the location of the mechanical abutment between the optical fiber stub 19 and the field fiber 14 (also referred to herein as the “splice location”). During installation of the field-installable optical fiber connector 10, field fiber 14 and optical fiber stub 19 are abutted together proximate view port 68 and a visible light, such as that from a HeNe laser or an LED, for example, is guided through one of the field fiber 14 or the optical fiber stub 19. If an incorrect abutment (i.e., mechanical joining point) is present, light guided by optical fiber stub 19 or field fiber 14 will be scattered at the opposing end face and will be visible through view port 68. When an acceptable abutment, or mechanical joining point, is present, substantially all of the light will be guided along optical fiber stub 19 and field fiber 14, with very little scattering occurring at the joining point. As a result, substantially less light from the laser or LED will be visible through view port 68. Accordingly, view port 68 provides a visual indication of an acceptable mechanical splice between the optical fiber stub 19 extending rearwardly from the ferrule 18 and the field fiber 14. View port 68 may also be used to provide access to the splice location for injecting an optical coupling material, such as a refractive index matching gel, into second cavity 63 to thereby improve the optical coupling between the optical fiber stub 19 and the field fiber 14.

As best shown in FIG. 3, splice holder 25 also defines a slot, or window 70 extending between second cavity 63 and the exterior surface of the splice holder to accommodate a keel portion of the lower splice component 28. Window 70 is generally located opposite view port 68. The second end 64 of the splice holder 25 is adapted to receive a lead in tube 80 (FIG. 1) having a longitudinally extending interior passageway for guiding the field fiber 14 into the second cavity 63 between the opposing splice components 26, 28. Preferably, the interior surface of second cavity 63 defines an axial groove or slot for receiving a key (not shown) located on the exterior surface of the lead in tube 80. When lead in tube 80 is inserted into the second end 64 of the splice holder 25, the key slidably engages with the groove or slot to prevent rotation of the lead in tube 80 relative to the splice holder 25, and consequently, relative to the ferrule holder 20 (which is fixed disposed within the splice holder) and the ferrule 18 (which is fixedly disposed within the ferrule holder). Lead in tube 80 may be secured within second end 64 of splice holder 25 with an adhesive, such as epoxy. Alternatively, lead in tube 80 may be press fit within splice holder 25, or may be secured by cooperative retaining elements in a known manner. Preferably, the interior passageway of the lead in tube 80 is sized to accommodate a crimp tube 85 (FIG. 1) and a portion of the passageway proximate the rearward end has a generally conical shape for guiding the field fiber 14 into the lead in tube 80. The crimp tube 85 may be formed from any suitable material, including copper, stainless steel or brass. To insert field fiber 14 into crimp tube 85, a portion of the jacket or coating surrounding field fiber 14 is removed to expose the bare glass of the field fiber. Enough coating material is removed from field fiber 14 such that the bare glass extends within connector 10 to abut with the optical fiber stub 19 between the splice components 26 and 28. When field fiber 14 has been inserted into crimp tube 85, the coated portion of field fiber 14 may be securely engaged, and thereby strain relieved, by crimping (i.e., deforming) the crimp tube 85 about the coated portion of the field fiber 14. The optical fiber connector 10 may further comprise an annular crimp band 90, which is mounted upon the second end 64 of the splice holder 25 proximate cam member 30. Crimp band 90 may be formed from any suitable material, including copper, stainless steel or brass. In embodiments as shown in FIG. 1 wherein the fiber optic cable 12 comprises one or more filamentary strength members 13 (e.g., aramid fibers) in addition to field fiber 14, the strength members 13 can be positioned between crimp band 90 and the exterior surface of splice holder 25 such that the strength members 13 are secured between the crimp band 90 and the splice holder 25 when the crimp band is crimped in a manner well known to those skilled in the art. Thereafter, a conventional connector boot 95, which has previously been positioned over field fiber 14 and cable 12, can be pulled over crimp band 90 so as to provide bending strain relief to the cable 12 adjacent the optical fiber connector 10.

Splice components 26 and 28 are inserted into second cavity 63 of splice holder 25 through second end 64 and positioned proximate view port 68 and window 70. First (i.e., upper) splice component 26 is generally adjacent view port 68, while second (i.e., lower) splice component 28 is generally adjacent window 70. As is known and described in greater detail in the related and co-pending patent applications, upper splice component 26 is configured with a flat surface opposite a guiding surface provided on lower splice component 28. Splice component 28 comprises a keel portion 29 (FIG. 1) that protrudes outwardly through the window 70 when splice component 28 is inserted into the second cavity 63 of the splice holder 25. The keel portion 29 is guided by a channel formed within the second cavity 63 from the second end 64 of splice holder 25 to the window 70, thereby facilitating insertion of the lower splice component 28 into second cavity 63 and the further insertion of the keel portion 29 through window 70. A longitudinally extending, generally V-shaped groove is provided on the guiding surface of lower splice component 28 opposite the keel portion 29 and opposing upper splice component 26. Alternatively, the V-shaped groove may be formed in the lower face of the upper splice component 26, and a generally flat face may be formed on the opposing upper face of the lower splice component 28. Splice components 26, 28 are prevented from moving forward within the second cavity 63 of the splice holder 25 by a shoulder 67 formed adjacent the intersection of the second cavity 63 with the passageway 60. When a ferrule 18 having a rearwardly extending optical fiber stub 19 is inserted through the passageway 40 of the ferrule holder 20 and into the passageway 60 of the splice holder 25, the free end of the optical fiber stub 19 projecting from the ferrule 18 is received within the V-shaped groove provided in one of the splice components 26, 28 and is positioned between the upper and lower splice components at a generally intermediate position within the second cavity 63 of the splice holder 25. When lead in tube 80 is inserted into second end 64 of splice holder 25, splice components 26, 28 are prevented from moving rearward within cavity 63 by the presence of the lead in tube 80. Thus, splice components 26 and 28 are prevented from axial movement within second cavity 63 by shoulder 67 and lead in tube 80 once the optical fiber connector 10 is at least partially assembled.

The cam member 30 is disposed about the splice holder 25 in an initial position generally proximate splice components 26, 28. The cam member 30 defines a longitudinally extending interior passageway 32 that is sized to receive, and therefore, be mounted upon the exterior surface of the splice holder 25. In order to actuate the splice components 26, 28, a portion of the interior passageway 32 defined by cam member 30 is preferably noncircular and comprises a major axis and a minor axis, as described in greater detail in the related and co-pending patent applications. The forward portion of the cam member 30 is noncircular on the inside and forms the major axis and minor axis, which in turn define the cam surface for engaging the keel portion 29 of the lower splice component 28. Preferably, cam member 30 also includes an outside surface 34 adapted to cooperate with a tool (not shown) for rotating the cam member 30 about the splice holder 25 and thereby actuating the splice components 26, 28. Cam member 30 also preferably includes a visual indicator to indicate the rotational position of cam member 30, and thus, the operational condition of splice components 26, 28 (i.e. actuated or un-actuated). For example, if the visual indicator is aligned with latching arm 15 of connector housing 16, the splice components 26, 28 are actuated and the optical fiber stub 19 and field fiber 14 are secured therebetween. Preferably, the cam member 30 is formed from a transparent or translucent plastic material such that light which may emit from view port 68 while evaluating optical fiber connector 10 for proper abutment (i.e., mechanical splice) between optical fiber stub 19 and field fiber 14 will be visible through cam member 30.

During pre-assembly of the optical fiber connector 10, ferrule holder 20 and splice holder 25 are inserted into the rearward opening of the interior 17 of connector housing 16 such that the first end 42 of the ferrule holder 20 (and hence ferrule 18) extend forward beyond the spring element seat formed within the interior 17 of the connector housing 16. Spring element 24 is positioned over the first end 42 of the ferrule holder 20 and compressed between the forward face of the spring element seat and the spring element retainer 22 to a predetermined spring (i.e., biasing) force. Thus, ferrule holder 20, ferrule 18 and splice holder 25 are all allowed to translate axially (i.e., piston) within the interior 17 of connector housing 16. Spring element retainer 22 may be engaged with the first end 42 of ferrule holder 20 by any suitable method known in the art. However, as shown and described in the exemplary embodiment herein, ferrule holder 20 is formed with screw threads 48 located proximate first end 42. Corresponding screw threads on the inside surface of spring element retainer 22 are configured to engage with screw threads 48 on ferrule holder 20. Thus, spring element retainer 22 may be removably fastened to first end 42 of ferrule holder 20 with spring element 24 compressed therebetween by engaging the internal threads of spring element retainer 22 with the external threads 48 on the first end 42 of ferrule holder 20. Alternatively, first end 42 and spring element retainer 22 may be designed such that spring element retainer 22 is snap fit to first end 42 of ferrule holder 20. Regardless, when optical fiber connector 10 has been assembled, spring element 24 preferably exerts a spring force between about 1 and about 1.5 lbs, and more preferably between about 1.1 and about 1.4 lbs, against spring element retainer 22 and ferrule holder 20.

According to the exemplary embodiment of the invention shown herein, a trigger 35 is slidably positioned over cam member 30. Trigger 35 is slid along cable 12 over the rear of cam member 30 and defines a longitudinally extending opening therethrough configured for receiving the barrel portion of cam member 30. More particularly, the longitudinally extending opening is configured for permitting the trigger 35 to be slid along the cable 12 and over the cam member 30 to engage the connector housing 16. Mating attachments 39 are provided on trigger 35 for releasably attaching and slidably engaging the connector housing 16. Preferably, the mating attachments 39 comprise resilient snap members provided on trigger 35 and longitudinal slots or grooves formed in connector housing 16. However, the locations of the snap members and grooves could be switched, or equivalent structures could be utilized. Further, the snap members may include chamfered edges to allow trigger 35 to be more easily slid onto the connector housing 16. The mating attachments may further comprise mating alignment elements for rotationally retaining the trigger 35 in a predetermined orientation relative to the connector housing 16. The alignment elements may comprise any variety of non-circumferential surfaces that interferingly prevent substantial rotation of trigger 35 relative to connector housing 16. For example, the alignment elements may comprise planar surfaces that contact one another when trigger 35 is positioned over the connector housing 16. Alternatively, the alignment elements may have shapes other than planar, such as oblong, oval, irregular, etc., within the scope of the invention.

When the alignment elements are aligned, latch 37 of trigger 35 is also aligned with latching arm 15 of connector housing 16 (unless trigger 35 has been installed upside down). If desired, the alignment elements could be configured so that incorrect attachment of trigger 35 onto connector housing 16 is difficult or impossible, for example by making the alignment elements non-symmetrical or irregular in some way. Latch 37 provides at least two functions. First, latch 37 is pivotable, as is latching arm 15, and engages the latching arm 15 to pivot it downward. Engagement of the latch 37 with the latching arm 15 moves the latching arm 15 downward to selectably release connector housing 16 from a receptacle, such as an adapter sleeve mounted on a patch panel. Latch 37 has a contoured surface for contacting the tip of latching arm 15 and assisting in pivoting the latching arm 15 downward when the latch 37 is depressed. Second, if cable 12 is pulled rearwardly, latch 37 reduces the possibility of latching arm 15 snagging on other cables, corners, or other fixtures along the routing path, since the latch 37 extends at an acute angle toward and beyond the tip of the latching arm 15. Preferably, the trigger 35 and connector housing 16 are formed of a suitable plastic material and molded in one piece so that the latch 37 and latching arm 15 each define a living hinge on the trigger 35 and the connector housing 16, respectively.

Field installation and assembly of the optical fiber connector 10 according to the present invention comprises inserting a field fiber 14 into the rearward opening of lead in tube 80 until field fiber 14 is abutted against the free end of optical fiber stub 19. Preferably, the end of field fiber 14 which is inserted into connector 10 is cleaved with a good end face, preferably with a cleave angle typically less than about one degree, to facilitate transmission therethrough. A light, such as a visible laser light or light from an LED, may be injected into the first end of optical fiber stub 19 to verify that the field fiber 14 and the optical fiber stub 19 are properly abutted. Once proper abutment is verified, the cam member 30 is turned in a direction which urges splice components 26 and 28 together, thereby securing the abutting ends of optical fiber stub 19 and field fiber 14 together in a position that facilitates transmission therethrough. For example, a tool (not shown) may be used to engage a complimentary portion of cam member 30 and to rotate the cam member 30 relative to the splice holder 25 to urge splice components 26 and 28 together. View port 68 may be observed during the installation to provide a visual indication of the quality of the splice between the optical fiber stub 19 and the field fiber 14, as previously described. When cam member 30 has been rotated and an acceptable mechanical splice indicated by a significantly diminished amount of light visible through view port 68, trigger 35 may then be slid along the cable 12 and positioned over the cam member 30 and connector housing 16. Once optical fiber stub 19 and the field fiber 14 have been secured together by splice components 26, 28, the remaining components of the mechanical splice connector 10, such as crimp band 90 and boot 95, may be assembled onto the connector 10 in a manner well known to those of ordinary skill in the art.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

1. An optical fiber connector comprising:
a connector body having a first end and a second end opposite the first end, the connector body defining a first cavity adjacent the first end;
a ferrule holder having a first end and a second end opposite the first end with the second end of the ferrule holder fixedly disposed within the first cavity of the connector body, the ferrule holder defining a recess adjacent the first end; and
a ferrule having a first end and a second end opposite the first end with the second end fixedly disposed within the recess of the ferrule holder.

2. An optical fiber connector according to claim 1, wherein the connector body and the ferrule holder are made of dissimilar materials.

3. An optical fiber connector according to claim 1, wherein the connector body is made of a plastic material and the ferrule holder is made of a metal material.

4. An optical fiber connector according to claim 1, wherein the connector body is made of a moldable material and the ferrule holder is made of a material that is stronger than the material of the connector body.

5. An optical fiber connector according to claim 1, wherein the ferrule holder is insert-molded within the connector body.

6. An optical fiber connector according to claim 1, wherein the ferrule holder further defines a longitudinal passageway in communication with and extending between the second cavity of the connector body and the recess of the ferrule holder, and wherein the ferrule further defines at least one longitudinal bore in communication with the passageway of the ferrule holder, an optical fiber stub being disposed within the bore of the ferrule, the passageway of the ferrule holder and the second cavity of the connector body.

7. An optical fiber connector according to claim 6, wherein at least one splice component is disposed within the second cavity of the connector body for splicing a field fiber to the optical fiber stub at a predetermined splice location.

8. An optical fiber connector according to claim 6, wherein the ferrule is retained in a predetermined position relative to the ferrule holder and the ferrule holder is retained in a predetermined position relative to the connector body such that the first end of the ferrule is maintained at a fixed distance from the splice location.

9. An optical fiber connector according to claim 8, wherein the connector body comprises a mechanical stop feature that cooperates with the second end of the ferrule holder to retain the ferrule holder in the predetermined position relative to the connector body.

10. An optical fiber connector according to claim 8, wherein the ferrule holder comprises a mechanical stop feature that cooperates with the second end of the ferrule to retain the ferrule in the predetermined position relative to the ferrule holder.

11. An optical fiber connector configured for performing a mechanical splice comprising:
a splice holder having a first end and a second end opposite the first end, the splice holder defining a longitudinally extending passageway comprising a first cavity adjacent the first end and a second cavity adjacent the second end;
a ferrule holder having a first end and a second end opposite the first end, the second end fixedly disposed within the first cavity of the splice holder, the ferrule holder defining a longitudinally extending passageway comprising a recess adjacent the first end;
a ferrule having a first end and a second end opposite the first end, the second end fixedly disposed within the recess of the ferrule holder, the ferrule defining at least one longitudinal bore therethrough for receiving an optical fiber stub; and
at least one splice component disposed within the second cavity of the splice holder for securing a field fiber to the optical fiber stub at a splice location;
wherein the splice holder and the ferrule holder are made of dissimilar materials.

12. An optical fiber connector according to claim 11, wherein the splice holder is made of a plastic material and the ferrule holder is made of a metal material.

13. An optical fiber connector according to claim 11, wherein the splice holder is made of a moldable material and the ferrule holder is made of a material that is stronger than the material of the connector body.

14. An optical fiber connector according to claim 11, wherein the ferrule holder is insert-molded within the splice holder.

15. An optical fiber connector according to claim 11, wherein the ferrule is retained in a predetermined position relative to the ferrule holder and the ferrule holder is retained in a predetermined position relative to the splice holder such that the first end of the ferrule is maintained at a fixed distance from the splice location.

16. An optical fiber connector according to claim 15, wherein the splice holder comprises a mechanical stop feature that cooperates with the second end of the ferrule holder to retain the ferrule holder in the predetermined position relative to the splice holder, and wherein the ferrule holder comprises a mechanical stop feature that cooperates with the second end of the ferrule to retain the ferrule in the predetermined position relative to the ferrule holder.

17. A mechanical splice connector comprising:
a connector housing defining an interior;
a splice holder at least partially disposed within the interior of the connector housing, the splice holder having a first end and a second end opposite the first end, the splice holder defining a longitudinally extending passageway comprising a first cavity adjacent the first end and a second cavity adjacent the second end;
a ferrule holder at least partially disposed within the interior of the connector housing, the ferrule holder having a first end and a second end opposite the first end with the second end of the ferrule holder fixedly disposed within the first cavity of the splice holder, the ferrule holder defining a longitudinally extending passageway in communication with the passageway of the splice holder and comprising a recess adjacent the first end; and
a ferrule at least partially disposed within the interior of the connector housing, the ferrule having a first end and a second end opposite the first end with the second end fixedly disposed within the recess of the ferrule holder, the ferrule defining a longitudinally extending bore in communication with the passageway of the ferrule holder for receiving and retaining therein an optical fiber stub.

18. A mechanical splice connector according to claim 17, further comprising:
a spring element retainer secured to the first end of the ferrule holder; and
a spring element disposed between the spring element retainer and the ferrule holder for biasing the ferrule relative to the connector housing with a predetermined spring force.

19. A mechanical splice connector according to claim 17, further comprising:
a pair of opposing splice components disposed within the second cavity of the splice holder, the splice components configured to receive and secure the optical fiber stub and a field fiber therebetween; and
a cam member disposed about the splice holder for actuating the splice components to secure the optical fiber stub and the field fiber together.

20. A mechanical splice connector according to claim 19, further comprising a view port extending through the splice holder into the second cavity for providing a visual indication of the quality of a mechanical splice between the optical fiber stub and the field fiber.
